(19) United States
(12) Patent Application Publication
(10) Pub. No.: US 2018/0376212 A1
(43) Pub. Date: Dec. 27, 2018

(54) MODIFYING DISPLAY REGION FOR PEOPLE WITH VISION IMPAIRMENT

(71) Applicant: Sony Corporation, Tokyo (JP)

(72) Inventors: Brant Candelore, Escondido, CA (US); Mahyar Nejat, San Diego, CA (US); Peter Shintani, San Diego, CA (US)

(21) Appl. No.: 15/631,669

(22) Filed: Jun. 23, 2017

(51) Int. Cl. H04N 21/4728; H04N 21/2343

(52) U.S. Cl. CPC H04N 21/4728; G06F 2203/04806; H04N 21/234345; H04N 21/234363

(57) ABSTRACT

The most active part of a video frame is magnified on a display to accommodate people with eye maladies such as glaucoma or retinitis pigmentosa. An area of interest in a video frame is identified, and that area is expanded or magnified. This may be done by the display recognizing where most of the action is taking place by means of with motion vectors and I-macroblocks, or by allowing the viewer to switch to various predetermined blocks on screen using a remote control.

### FIELD

The present application relates to technically inventive, non-routine solutions that are necessarily rooted in computer technology and that produce concrete technical improvements.

### BACKGROUND

Visual impairments include maladies that cause loss of peripheral vision, such as glaucoma and sometimes retinitis pigmentosa, and maladies that cause loss of vision in the center of view, such as macular degeneration. People suffering from such impairments can experience difficulty viewing a video screen such as a TV because they must move their heads to see the entire video frame.

### SUMMARY

Present principles recognize the above problems experienced by visually impaired people and so the most active part of the video is magnified. That is, the area of interest, e.g., someone talking, a vehicle coming up a valley, etc. is magnified. The viewer is assumed to sit a predetermined distance from the display to make the image fit in what can be seen without moving the head left to right and up and down. This may be done by the display processor or a server recognizing where most of the action is taking place with motion vectors and I-macroblocks, or by enabling the viewer maybe to switch to various predetermined blocks on screen using a remote control.

Accordingly, a device includes at least one computer memory that is not a transitory signal and that includes instructions executable by at least one processor to receive identification of at least one video item of interest (VII). The instructions are also executable to identify, in at least one video frame for presentation on the video display, the VII, and to enlarge the VII relative to a size of the VII received in the video frame to render an enlarged VII which is presented in lieu of presenting the VII received in the video frame. The computer memory may be implemented in a display device receiving the VII and presenting it, or it may be implemented in a server, which sends only the enlarged VII (i.e., the minimal video content) to a display device for presentation thereof.

In some examples, the instructions are executable to identify an existence of a vision impairment at least in part by receiving an image of a viewer, executing image recognition on the image to render a result, and using the result to access a database having information useful in identifying the existence of vision impairment of the user. The VII may be enlarged responsive to identifying the existence of vision impairment.

In non-limiting implementations the instructions are executable to identify the vision impairment at least in part by receiving input from at least one user interface (UI) indicating a type of visual impairment. In some embodiments the instructions are executable to identify the vision impairment at least in part by sending to at least one server at least one identification (ID). The ID includes an ID of the video display and/or an ID of a person, and an indication of the vision impairment is received back from the server responsive to sending the ID. Yet again, the instructions may be executable to receive the identification of the VII at least in part by accessing a data store of default VII, and/or by receiving input from at least one user interface (UI) indicating at least one VII.

In example embodiments the instructions are executable to identify, in at least one video frame for presentation on the video display, the VII at least in part by selecting a portion of a video frame as the VII responsive to the portion being characterized by one or more motion vectors satisfying a first test. In addition or alternatively, the instructions may be executable to identify, in at least one video frame for presentation on the video display, the VII at least in part by executing image recognition on at least one video frame to identify a VII. Yet again, the instructions can be executable to identify, in at least one video frame for presentation on the video display, the VII at least in part by receiving a selection of a portion of a video frame as the VII responsive to the portion being characterized by one or more histograms satisfying a first test. If desired, the instructions can be executable to automatically amplify sound associated with a VII responsive to identifying, in at least one video frame for presentation on the video display, the VII.

In another aspect, a method includes identifying a portion of a video frame as being of interest. The portion is more than zero percent and less than one hundred percent of the video frame, and the method includes identifying an existence of a human impairment. Responsive to identifying the existence of a human impairment, the method includes enlarging the portion. The method may be executed by a display device receiving the video frame for presentation or by a server, which then sends only the portion of the video frame to the display device.

In another aspect, an assembly includes a processor, a display for control by the processor, and a storage with instructions executable by the processor to receive identification of at least one item of interest (II). The instructions are executable to identify, in at least one content frame for presentation on the display, the II, and to amplify and/or enlarge the II to render and amplified and/or enlarged II which is presented in lieu of presenting the II received in the content frame.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example consistent with present principles;

FIG. 2 is a flow chart of example logic for identifying (defining) video elements of interest to be moved to the sweet spot and magnified;

FIG. 3 is an example screen shot of an interface related to FIG. 2;

FIG. 4 is a flow chart of example logic for identifying predefined video elements of interest in a demanded video stream;

FIGS. 5 and 6 are before and after depictions, respectively, of video presentation illustrating the effects of magnifying a video element of interest; and

FIGS. 7 and 8 are a flow chart and a screen shot, respectively, of an alternate embodiment.

### DETAILED DESCRIPTION

This disclosure relates generally to computer ecosystems including aspects of consumer electronics (CE) device based user information in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network. A server or controller may be instantiated by a game console such as a Sony Playstation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

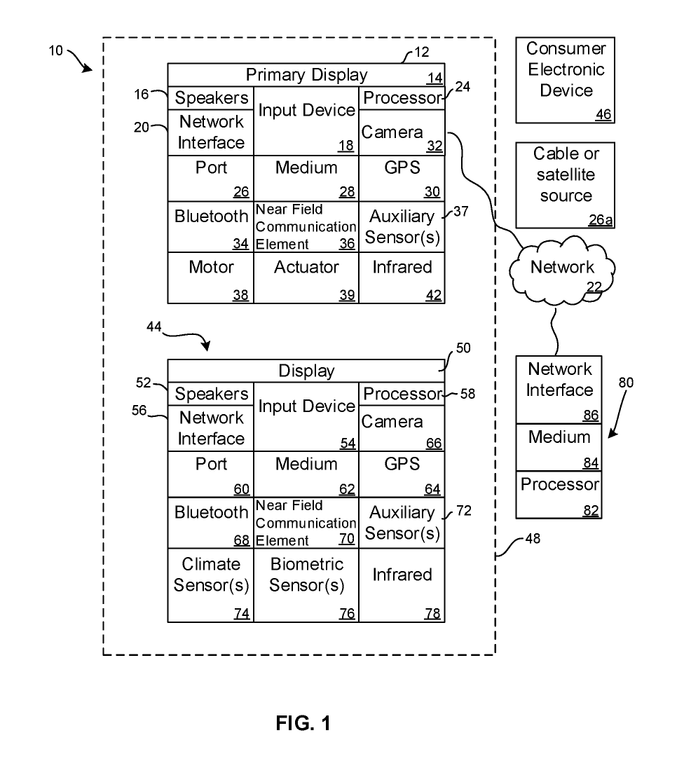

Now specifically referring to FIG. 1, an example ecosystem 10 is shown, which may include one or more of the example devices mentioned above and described further below in accordance with present principles. The first of the example devices included in the system 10 is an example primary display device, and in the embodiment shown is an audio video display device (AVDD) 12 such as but not limited to an Internet-enabled TV. Thus, the AVDD 12 alternatively may be an appliance or household item, e.g. computerized Internet enabled refrigerator, washer, or dryer. The AVDD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition “4K” or “8K” (or higher resolution) flat screen and that may be touch-enabled for receiving consumer input signals via touches on the display. The AVDD 12 may include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a USB port to physically connect (e.g. using a wired connection) to another CE device and/or a headphone port to connect headphones to the AVDD 12 for presentation of audio from the AVDD 12 to a consumer through the headphones. The AVDD 12 may further include one or more computer memories 28 that are not transitory signals, such as disk-based or solid state storage (including but not limited to flash memory). Also in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVDD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command, etc.) providing input to the processor 24. The AVDD 12 may include still other sensors such as e.g. one or more climate sensors 38 (e.g. barometers, humidity sensors, wind sensors, light sensors, temperature sensors, etc.) and/or one or more biometric sensors 40 providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still referring to FIG. 1, in addition to the AVDD 12, the system 10 may include one or more other CE device types. In one example, a first CE device 44 may be used to control the display via commands sent through the below-described server while a second CE device 46 may include similar components as the first CE device 44 and hence will not be discussed in detail. In the example shown, only two CE devices 44, 46 are shown, it being understood that fewer or greater devices may be used.

In the example shown, to illustrate present principles all three devices 12, 44, 46 are assumed to be members of an entertainment network in, e.g., in a home, or at least to be present in proximity to each other in a location such as a house. However, for illustrating present principles the first CE device 44 is assumed to be in the same room as the AVDD 12, bounded by walls illustrated by dashed lines 48.

The example non-limiting first CE device 44 may be established by any one of the above-mentioned devices, for example, a portable wireless laptop computer or notebook computer, and accordingly may have one or more of the components described below. The second CE device 46 without limitation may be established by a wireless telephone. The second CE device 46 may implement a portable hand-held remote control (RC).

The first CE device 44 may include one or more displays 50 that may be touch-enabled for receiving consumer input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is an example of a wireless computer network interface. It is to be understood that the processor 58 may control the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a USB port to physically connect (e.g. using a wired connection) to another CE device and/or a headphone port to connect headphones to the first CE device 44 for presentation of audio from the first CE device 44 to a consumer through the headphones. The first CE device 44 may further include one or more computer memories 62 such as disk-based or solid state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command, etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44.

The second CE device 46 may include some or all of the components shown for the CE device 44.

Now in reference to the afore-mentioned at least one server 80, it includes at least one server processor 82, at least one computer memory 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server, and may include and perform “cloud” functions such that the devices of the system 10 may access a “cloud” environment via the server 80 in example embodiments. Or, the server 80 may be implemented by a game console or other computer in the same room as the other devices shown in FIG. 1 or nearby.

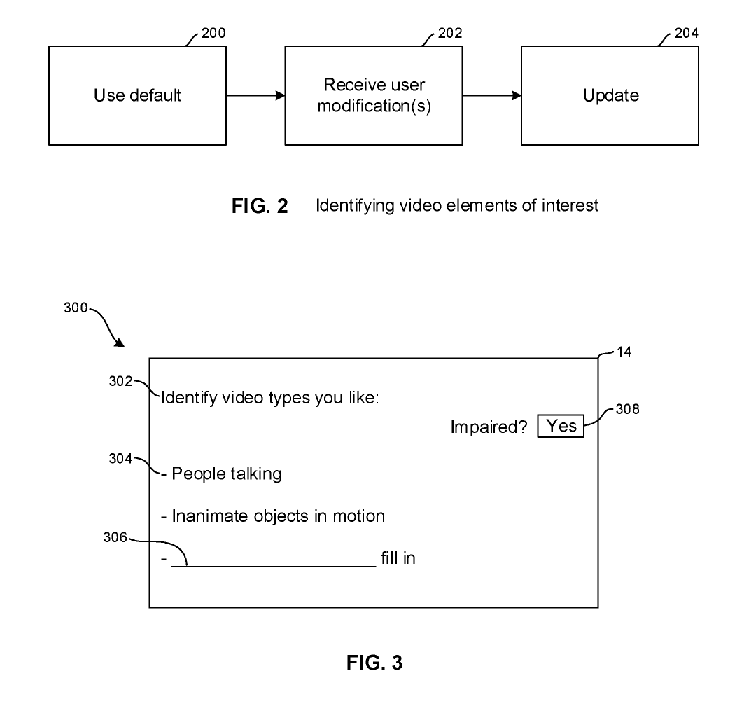

FIG. 2 shows an example logic flow of identifying video items of interest in a video to magnify and/or move those items according to description below. The logic may be implemented by a display device receiving video for presentation on the display device, or by a server that sends only a portion of video frames to a display device per the logic below, or a combination thereof.

A default set of video items of interest may be identified at block 200. The default set may include video object types, for example, someone speaking, an object moving whose motion vectors satisfy a speed threshold, an object moving in a particular back background such as a vehicle coming up a valley, etc.

At block 202 user modifications, such as additions and deletions, to the default set may be received. The set of video items of interest is then updated according to the user modifications at block 204.

FIG. 3 illustrates an example user interface (UI) 300 that may be presented, e.g., on the display 14 of the AVDD 12. The UI 300 may also or alternatively be presented audibly on the speakers 16. The UI 300 may be presented alternatively or in addition on another device, such as the CE device 44.

The UI 300 may include a prompt 302 to the user to identify particular video items of interest the user prefers. Various predefined options 304 may be presented and may be selected to add them to the default set discussed above. Also, a field 306 may be provided to enable the user to type in (using, e.g., a keypad such as any of those described above) or speak (using, e.g., a microphone such as any of those described above) a video object type that may not appear in the predefined list of options 304. Toggling a selection may remove it from the set of video items of interest.

Also, an “impaired” selector 308 may be provided that can be selected to indicate that a viewer has a visual impairment. The selector 308 may additionally or alternatively indicate that selection indicates a hearing impairment. For ease of description the discussion below focuses on visually magnifying video items of interest, it being understood that for visually impaired people, sound associated with video items of interest may be amplified above the current volume setting of the AVDD.

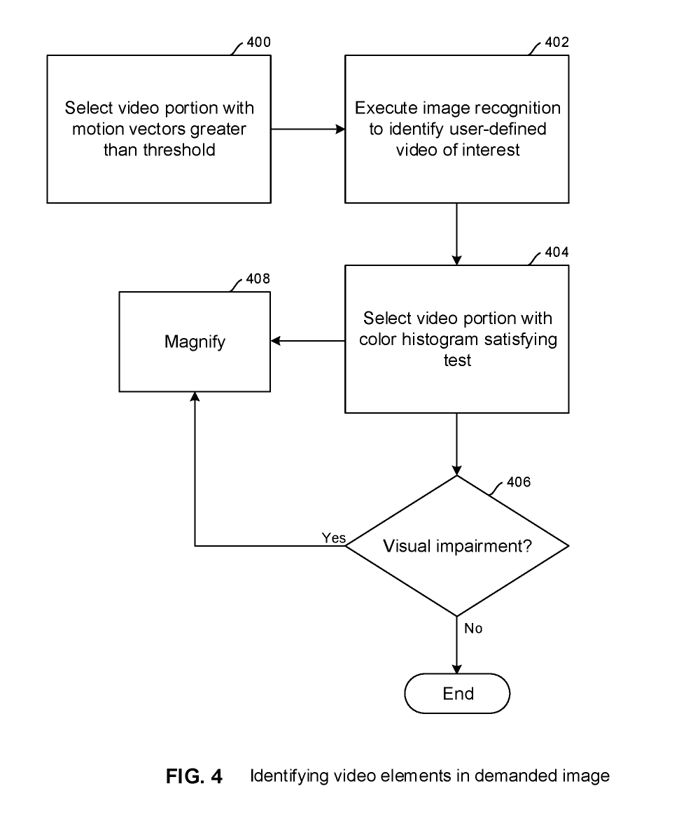

Once video items of interest are defined, the logic of FIG. 4 may be executed. It is to be understood that in executing logic herein, it may be assumed that the viewer will sit a predetermined proper distance from the AVDD to make the magnified image fit in what can be seen without requiring the viewer to move his head left to right or up and down.

In the example of FIG. 4, at block 400 the processor of the AVDD 12 or other suitable processor communicating with the AVDD 12 selects a portion of a video frame or frames less than 100% of the frame (but greater than zero) in which motion vectors associated with the portion in I-macroblocks of the video satisfy a threshold, typically by meeting or exceeding a magnitude threshold. In other words, block 400 assumes that a video element of interest is one that is moving relatively quickly in the video.

In addition or alternatively, image recognition may be executed on the video at block 402 to identify objects in the list of video elements of interest discussed above, including user-defined objects of interest. Yet again, at block 404 in addition or alternatively to the selections at blocks 400 and 402, a portion of a video frame or frames less than 100% of the frame but greater than zero is selected based on the portion having a color histogram satisfying a test, such as a histogram indicating a wide range of colors in the selected portion.

Proceeding to decision diamond 406, in some implementations it may be determined whether a viewer has an impairment such as a visual impairment, and if so the logic moves to block 408 to magnify video items of interest, in place if desired. Equivalently, for hearing-impaired viewers the sound associated with video items of interest is amplified to a louder volume than the current volume setting of the AVDD.

The determination at diamond 406 may be made based on the viewer input at selector 308 in FIG. 3. However, it may alternatively or additionally be made by the AVDD sending to the server 80 an ID that includes an ID of the AVDD (such as model and serial number) and/or an ID of a viewer as determined by user input or face recognition using the cameras 32 or voice recognition using the microphone of the AVDD. The server can correlate the ID(s) to a database of viewers with visual or hearing impairments and return a signal to the AVDD indicating that a viewer has an impairment and if desired, what type of impairment.

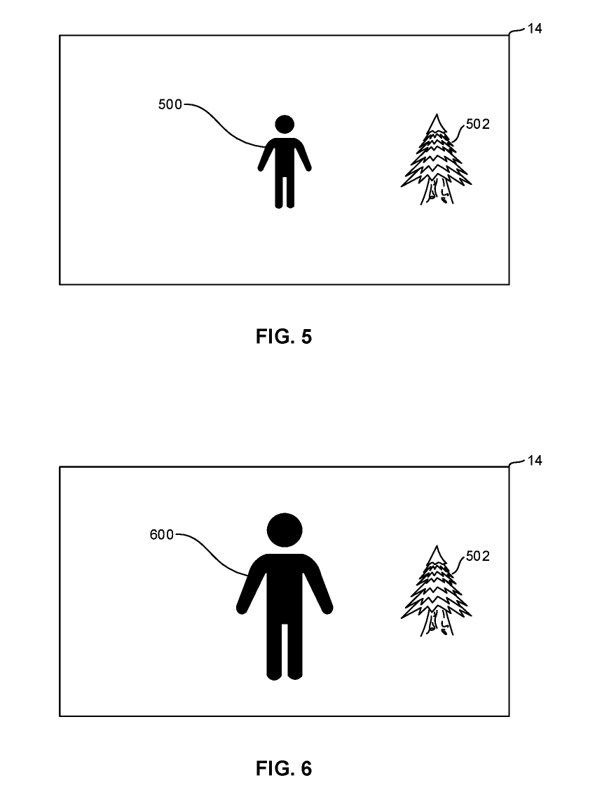

Indeed, FIGS. 5 and 6 illustrate that once a video object of interest 500 is identified in a video in which objects 502 that are not video elements of interest according to the description above also appear, the video objects of interest 500 are magnified into magnified objects of interest 600, with the objects 502 that are not video elements of interest remaining sized as received in the video stream from the source of video, in the same place as received if desired. For example, a center pixel of the magnified image 600 may occupy the same display point as the center pixel of the original image 500.

Magnification may be accomplished by adding extrapolated pixels between pixels of the originally-sized video object of interest 500 or by other suitable means.

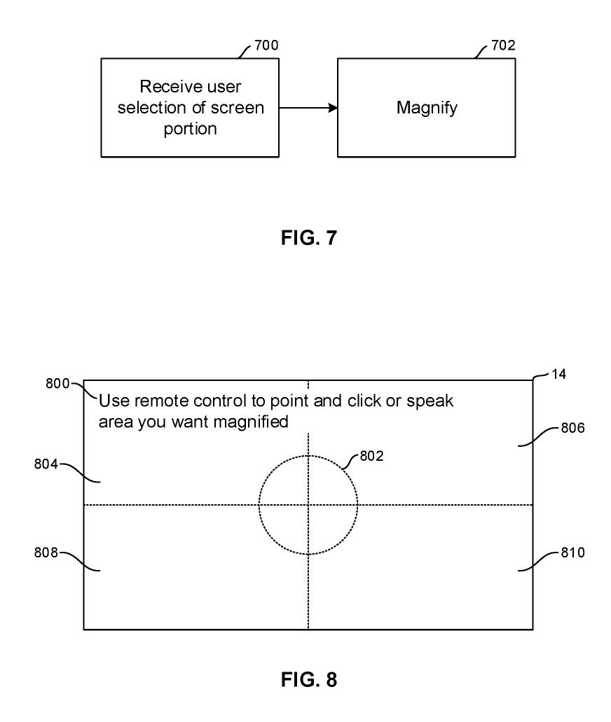

FIGS. 7 and 8 illustrate an alternate embodiment in which the user can select blocks on the display to magnify using a remote control such as the CE device 46 when so embodied. In FIG. 7, at block 700 a user selection of a screen portion is received and at block 702 the selected portion is magnified.

FIG. 8 illustrates. A message 800 may be presented on the display 14 of the AVDD 12 and/or on the speakers 16 to prompt the user to select a screen area to be magnified using an RC or by speech. For example, the user may use an RC to move a screen cursor to a center location 802 or may speak “center” to cause the center portion to be magnified. Likewise, the user may use an RC to move a screen cursor to an upper left portion 804 of the screen or may speak “upper left” to cause the upper left portion to be magnified. Or, the user may use an RC to move a screen cursor to an upper right portion 806 of the screen or may speak “upper right” to cause the upper right portion to be magnified. The user may use an RC to move a screen cursor to a lower left portion 808 of the screen or may speak “lower left” to cause the lower left portion to be magnified. Yet again, the user may use an RC to move a screen cursor to a lower right portion 810 of the screen or may speak “lower right” to cause the lower right portion to be magnified.

While particular techniques are herein shown and described in detail, it is to be understood that the subject matter which is encompassed by the present application is limited only by the claims.

1. A device comprising:
at least one computer memory, implemented by a video device configured to present video and/or by a server communicating with the video device, the memory not being a transitory signal and comprising instructions executable by at least one processor to:
receive identification of at least one video item of interest;
identify, in at least one video frame for presentation on a video display, the video item of interest at least in part responsive to a video object representing the video item of interest being characterized by one or more motion vectors in at least one macroblock of video satisfying a first test; and
enlarge the video item of interest relative to a size of the video item of interest received in the video frame to render an enlarged video item of interest which is presented in lieu of presenting the video item of interest received in the video frame.

2. The device of claim 1, wherein the instructions are executable to identify an existence of a vision impairment at least in part by:
receiving an image of a viewer;
executing image recognition on the image to render a result;
using the result to access a database having information useful in identifying the existence of vision impairment of the user, wherein the video item of interest is enlarged responsive to identifying the existence of vision impairment.

3. The device of claim 2, wherein the instructions are executable to identify the vision impairment at least in part by:
receiving input from at least one user interface (UI) indicating a type of visual impairment.

4. The device of claim 2, wherein the instructions are executable to identify the vision impairment at least in part by:
sending to at least one server at least one identification (ID), the ID including an ID of the video display and/or an ID of a person; and
receiving back from the server indication of the vision impairment responsive to the ID.

5. The device of claim 1, wherein the instructions are executable to receive the identification of the at least one video item of interest at least in part by:
accessing a data store of default video item of interest.

6. The device of claim 1, wherein the instructions are executable to receive the identification of the at least one video item of interest at least in part by:
receiving input from at least one user interface (UI) indicating at least one video object type to be a video item of interest.

7. (canceled)

8. The device of claim 1, wherein the instructions are executable to identify, in at least one video frame for presentation on the video display, the video item of interest at least in part by:
executing image recognition on at least one video frame to identify a video item of interest.

9. The device of claim 1, wherein the instructions are executable to identify, in at least one video frame for presentation on the video display, the video item of interest at least in part by:
receiving a selection of a portion of a video frame as the video item of interest responsive to the portion being characterized by one or more histograms satisfying a first test.

10. The device of claim 1, wherein the instructions are executable to automatically amplify sound associated with a video item of interest responsive to identifying, in at least one video frame for presentation on the video display, the video item of interest.

11. A method comprising:
identifying a portion of a video frame as being of interest, the portion being more than zero percent and less than one hundred percent of the video frame, the identifying comprising executing image recognition on at least one video object in at least one frame to identify a video item of interest;
identifying an existence of a human impairment; and
responsive to identifying the existence of a human impairment, enlarging the portion, wherein the method is implemented by a server or a video device presenting the portion.

12. The method of claim 11, wherein the portion comprises at least one video item of interest.

13. The method of claim 12, comprising:
receiving an image of a viewer;
executing image recognition on the image to render a result;
using the result to access a database having information useful in identifying the existence of vision impairment of the user, wherein the video item of interest is enlarged responsive to identifying the existence of vision impairment.

14. The method of claim 12, comprising:
receiving input from at least one user interface (UI) indicating a type of visual impairment.

15. The method of claim 12, comprising:
sending to at least one server at least one identification (ID), the ID including an ID of the video display and/or an ID of a person; and
receiving back from the server indication of the vision impairment responsive to the ID.

16. The method of claim 11, comprising: receiving an identification of the video item of interest at least in part by:
receiving input from at least one user interface (UI) indicating at least one video object type to be a video item of interest.

17. The method of claim 11, wherein identifying a portion of a video frame as being of interest comprises receiving a selection of a portion of a video frame as the video item of interest responsive to the portion being characterized by one or more motion vectors satisfying a first test.

18. (canceled)

19. The method of claim 11, comprising automatically amplifying sound associated with the portion.

20. An assembly, comprising:
at least one processor;
at least one display for control by the processor; and
at least one storage with instructions executable by the processor to:
receive identification of at least one item of interest;
identify, in at least one content frame for presentation on the display, the item of interest at least in part based on receiving a selection of a portion of a video frame as the video item of interest being characterized by one or more histograms satisfying a first test; and
amplify or enlarge the item of interest to render an amplified or enlarged item of interest which is presented in lieu of presenting the item of interest received in the content frame.
